(19) United States
(12) Patent Application Publication
(10) Pub. No.: US 2004/0190715 A1
(43) Pub. Date: Sep. 30, 2004

(54) File security management method and file security management apparatus

(75) Inventors: Naoki Nimura, Kawasaki (JP); Taki Kono, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/785,053

(22) Filed: Feb. 25, 2004

(30) Foreign Application Priority Data
Mar. 31, 2003 (JP) 2003-095722

(51) Int. Cl. H04L 9/00

(52) U.S. Cl. 380/44

(57) ABSTRACT

A file cannot be opened in a position other than a specified position in a way such that position information is obtained from a GPS device and filtered according to an encryption level. Data is encrypted by using the filtered position information as a key. A header and a digest are created, and their data are saved. To open the file encrypted by using the position information, it must be decrypted by using position information which is specified when the file is saved, whereby the file cannot be specified in a location other than the specified location.

### BACKGROUND OF THE INVENTION

1. Field of the Invention

The present invention relates to a file security management method and a file security management apparatus.

2. Description of the Related Art

With the popularization of networks such as the Internet, etc., users have been able to access a system via a network. Generally, to prevent an illegal access to a system, an individual authentication code is given to a user, and login is permitted if an input authentication code and a preregistered authentication code match.

However, the above described authentication system has a problem that a person other than a permitted user can make an access if an authentication code is known to another person.

To overcome such a problem, there is a technique that prevents an illegal access by making a cellular phone comprise a GPS function, by preregistering a position range in which an access can be made to a system, and by denying an access if the position of the cellular phone is outside the reregistered position range (for example, see Patent Document 1).

There is also a technique that prevents data stored in a portable information terminal from being leaked by storing the use behavior range of the portable information terminal onto a storage medium, and by executing a file deletion process if the current position of the portable information terminal, which is read from a GPS control module, is not within the preregistered use behavior range (for example, see Patent Document 2).

[Patent Document 1]

Japanese Patent Publication No. 2002-327562 (FIG. 5, and paragraphs 0024 and 0025)

[Patent Document 2]

Japanese Patent Publication No. 2003-18652 (FIG. 3, and paragraph 0015)

In a company, a public institution, a library, etc., electronic documents that can be freely viewed in their areas, but are prohibited from being carried outside exist. Hereafter, as documents in a company, a public institution, etc. are made electronic more and more, the number of electronic documents that are prohibited from being carried outside is expected to increase.

An illegal access or an illegal use of data when a cellular phone or portable information terminal itself is carried outside a predetermined position range can be prevented. However, an electronic document can be copied if a position range is within a permitted position range, or an original electronic document can be carried outside a permitted position range.

### SUMMARY OF THE INVENTION

An object of the present invention is to make it impossible to open a file in a location other than a specified location.

One mode of a file security management method according to the present invention comprises: encrypting a file by using, as a key, position information which specifies a position in which the file can be opened; saving the file which is encrypted by using the position information as a key; decrypting the file by using, as a key, position information which is detected by a position detecting device; and displaying the decrypted file.

According to the present invention, a file can be freely opened in a position specified when the file is saved, but cannot be opened in a position other than the specified position. Accordingly, even if the file is copied in a location in which the file can be opened, and carried outside, or even if an information processing device of a portable type in which the file is stored is carried to a location other than the specified position, the file cannot be opened in a location other than the specified location. As a result, the file can be prevented from being illegally used.

Another mode of the present invention is to allow a selection to be made from among a plurality of preregistered positions when information of a position in which a file can be decrypted is selected.

With such a configuration, an arbitrary position is specified from among a plurality of preregistered positions when a file is stored, whereby the position in which the file can be opened can be specified.

A further mode of the present invention is to impose a limitation on a range in which the file can be opened by changing the data length of position information used as an encryption key.

With such a configuration, a position range in which the file can be opened can be arbitrarily limited, for example, by truncating which digit and its subsequent digits of position information, whereby a user can arbitrarily set the strength of security.

### BRIEF DESCRIPTION OF THE DRAWINGS

FIGS. 1A and 1B show the basic configuration of a file security management apparatus;

FIG. 2 explains the functions of an information processing device according to a preferred embodiment;

FIG. 3 shows a tool bar of an application;

FIG. 4 is a flowchart showing a data saving process according to a first preferred embodiment;

FIG. 5 shows the relationship between a security level, a filter, and GPS information;

FIG. 6 explains a security level;

FIG. 7 shows the data structure of an encrypted file;

FIG. 8 shows the structure of a header;

FIG. 9 is a flowchart showing a process executed when data is saved by specifying a current location;

FIG. 10 is a flowchart showing a process executed when data is saved by specifying latitude and longitude;

FIG. 11 explains a specification method when data is saved by specifying a location;

FIG. 12 is a flowchart (No. 1) showing a process executed when a file is opened;

FIG. 13 is a flowchart (No. 2) showing a process executed when a file is opened;

FIG. 14 is a flowchart showing a data transmission/saving process according to a second preferred embodiment;

FIG. 15 shows the structure of encrypted data;

FIG. 16 is a flowchart showing a process executed when a file is opened;

FIG. 17 explains a third preferred embodiment;

FIG. 18 is a flowchart showing a process for opening encrypted map data, according to a fourth preferred embodiment;

FIG. 19 explains the case where map information is recorded onto a storage medium;

FIG. 20 explains the case where an access key is recorded onto a removable medium;

FIG. 21 is a flowchart showing a process for executing a license protection file, according to a fifth preferred embodiment; and

FIG. 22 shows the configuration of an information processing device.

### DESCRIPTION OF THE PREFERRED EMBODIMENTS

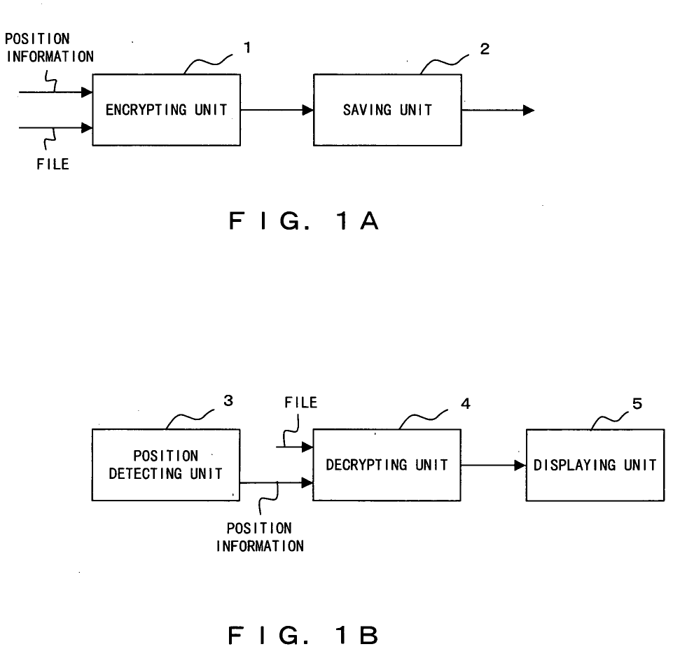

FIGS. 1A and 1B show the basic configuration of a file security management apparatus according to the present invention.

As shown in FIG. 1B, the file security management apparatus comprises: an encrypting unit 1 encrypting a file by using, as a key, position information which specifies a position in which the file can be opened; a saving unit 2 saving the encrypted file by using the position information as a key; a decrypting unit 4 decrypting the file by using, as a key, position information which is detected by a position detecting unit 3; and a displaying unit 5 displaying the file decrypted by the decrypting unit 4.

With this security management apparatus, a file can be freely opened in a position specified when the file is stored, but cannot be opened in a position other than the specified position, whereby the security of the file can be enhanced.

FIG. 1A shows the basic configuration of another file security management apparatus. This security management apparatus comprises: an encrypting unit 1 encrypting a file by using, as a key, position information which specifies a position in which the file can be opened; and a saving unit 2 saving the encrypted file by using the position information as a key.

With this security management apparatus, a file can be freely opened in a position specified when the file is stored, but cannot be opened in a position other than the specified position, so that the security of the file can be enhanced.

A file security management method according to a preferred embodiment of the present invention is described below with reference to the drawings. The preferred embodiment to be described below shows an example where a security management program based on the file security management method is embedded in an application program for creating a document.

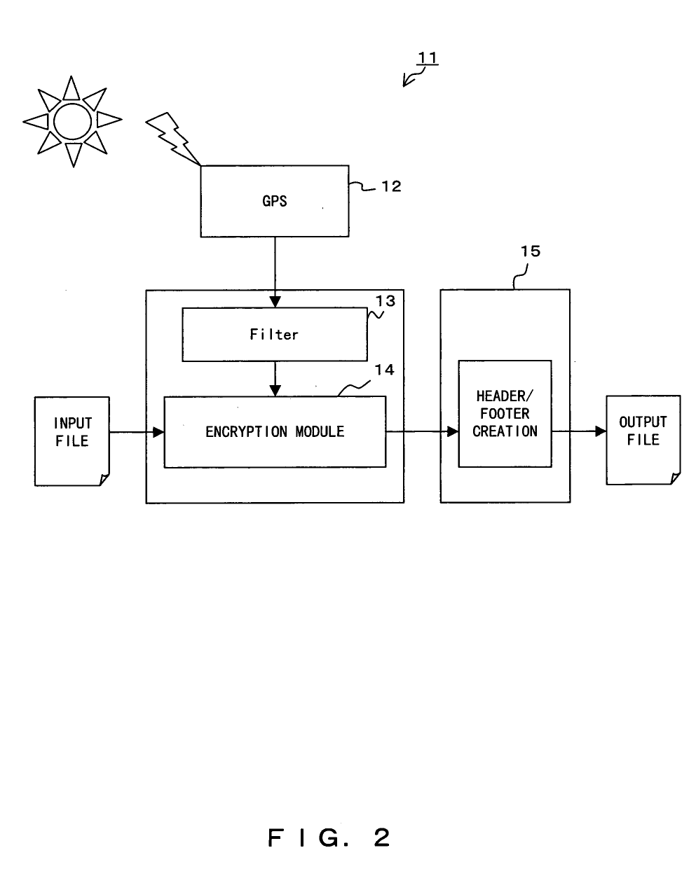

FIG. 2 explains the functions of an information processing device (security management apparatus) 11 in which the file security management program according to the preferred embodiment is installed. The information processing device is, implemented, for example, by a personal computer.

A GPS (Global Positioning System) device (position detecting device) 12 receives radio waves from a plurality of GPS satellites, and calculates position information composed of latitude and longitude data of a current position.

A filter unit 13 filters the position information to convert it into position information having a predetermined data length, and outputs the position information to an encryption module (encrypting unit) 14. An encryption level of data, namely, to which extent a position range where a file can be opened is set is specified by a user. Therefore, the filter unit 13 executes a filter process, which corresponds to the encryption level specified by the user, for the position information, and outputs the position information having a corresponding data length as an encryption key.

The encryption module 14 encrypts an input file (document data) by using, as a key, the position information output from the filter unit 13.

A saving unit 15 stores data, which indicates the level of encryption, in the header of the data of the encrypted file, also stores a digest created from the encrypted data in a footer, and outputs these items of data as one file. The encrypted file is saved in an external storage device such as a hard disk, etc.

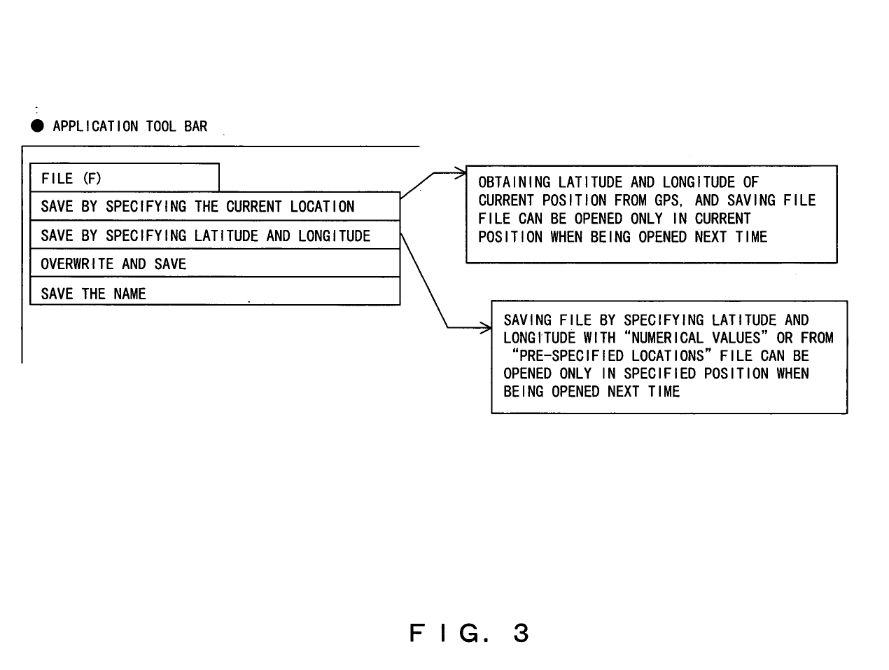

FIG. 3 exemplifies a tool bar in the case where the file security management program is embedded in an application for creating a document.

In a menu in a lower hierarchy of file items of the tool bar displayed in an upper portion of a display screen, two options such as “save by specifying the current location”, which specifies the current position as a location in which a file can be opened, and “save by specifying latitude and longitude”, which saves a file by specifying latitude and longitude of a location in which the file can be opened, are added in addition to the conventional options such as “overwrite and save”, and “save with a name”.

For example, if “save by specifying latitude and longitude” is selected, a user can specify latitude and longitude when saving a file, or can set a pre-specified location in the file as a location in which the file can be opened. As a method setting a location in which a file can be opened in a file, data is encrypted and stored by using, as a key, position information of a location in which the file can be opened. As a result, when the file is opened, it must be decrypted by using, as a key, the position information used for the encryption, thereby making it impossible to open the file in a location other than the specified location.

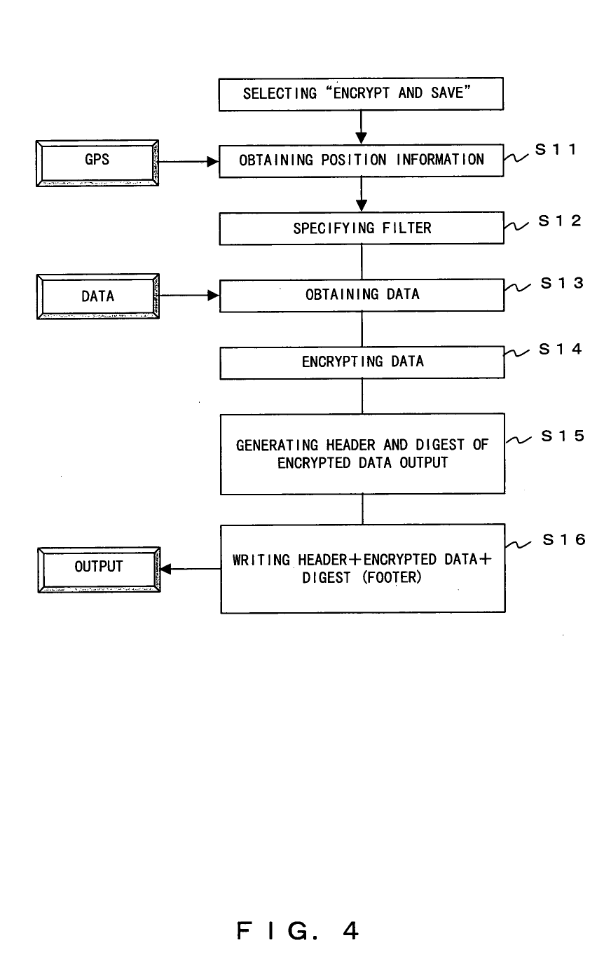

FIG. 4 is a flowchart showing a process for encrypting and saving data, according to the first preferred embodiment of the present invention. The process to be described below is executed by a CPU of the information processing device 11, and data resultant form the process is stored in a memory, a hard disk, etc.

If “encrypt and save” is selected when document data, etc. is saved, the CPU obtains GPS information from the GPS device 12 (step S11 of FIG. 4).

Then, if a security level at the time of encryption is specified by a user, a filter which corresponds to the security level is specified (step S12 of FIG. 4).

Next, data to be encrypted and saved is obtained (step S13 of FIG. 4). Then, the data is encrypted by using, as a key, the latitude and longitude data of the GPS information by a predetermined number of high-order digits, which is specified by the filter corresponding to the security level (step S14 of FIG. 4).

Here, the security level is data for determining data of up to which digit of degree, minute, and second data of latitude and longitude data is used as an encryption key.

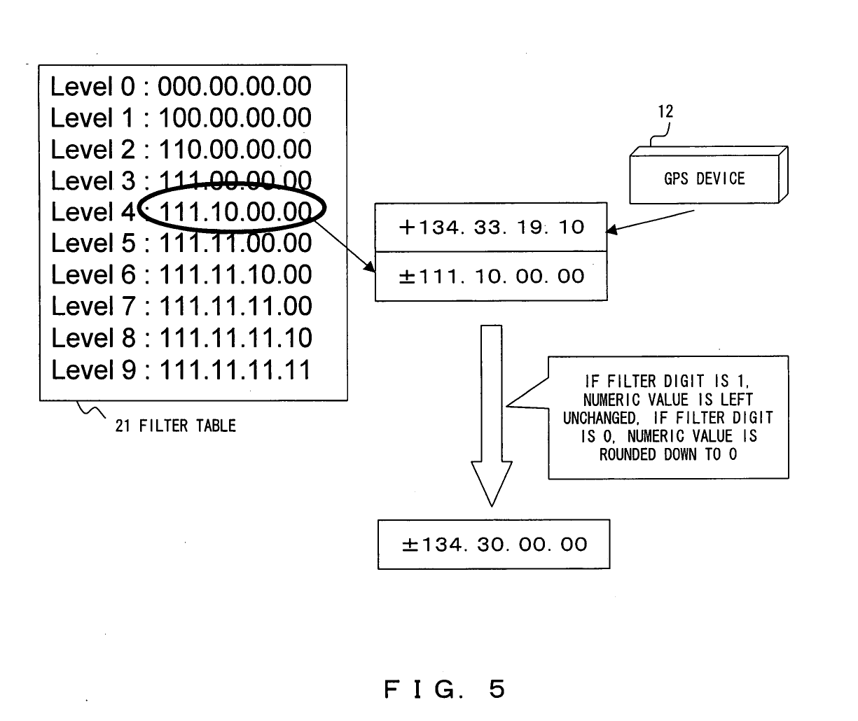

In the first preferred embodiment, as shown in FIG. 5, a filter table 21 which makes a correspondence between a security level and a filter value is provided. A user specifies a security level (position range where a file can be opened) when saving a file, so that data of up to which high-order digit of latitude and longitude data is determined to be used as an encryption key.

For example, if a security level 4 is selected, [111.10.00.00] is selected as a filter value from the filter table 21 shown in. FIG. 5, and this value and longitude data, for example, 134 degrees 33 minutes 19 seconds 10 ([134.33.19.10]) east longitude, which is output from the GPS device 12, are multiplied. As a result of this calculation, longitude data which corresponds to a digit of 1 of the filter value is output unchanged, and longitude data which corresponds to a digit of 0 of the filter value becomes 0, and ┌134.30.00.00┘ is obtained as an encryption key.

A security level indicates up to which high-order digit of latitude and longitude data is used as valid data. By changing a security level, a position range in which encrypted data can be decrypted can be arbitrarily set.

A security level 0 in the filter table 21 shown in FIG. 5 corresponds to the case where encryption is not made, and a security level 1 corresponds to the case where an encryption key length is the shortest. At this level, a file can be opened in the widest range. A security level 9 corresponds to the case where all of digits of longitude or latitude data are used as an encryption key. At this level, the strength of security can be made highest.

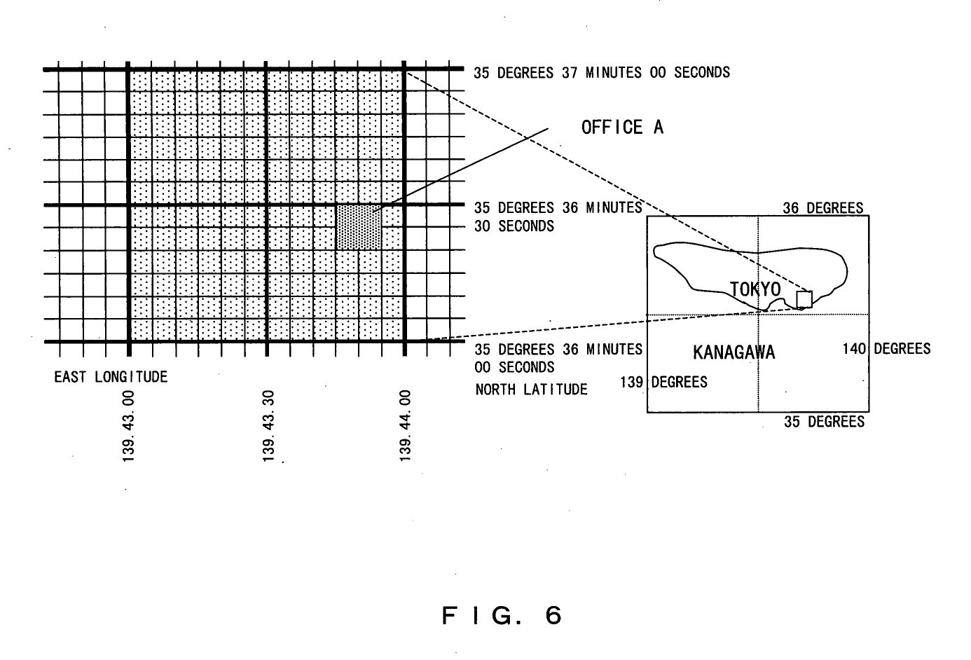

FIG. 6 shows a position range determined by a security level. For example, if an office A exists in a range from 139 degrees 43 minutes 45 to 55 seconds east longitude to 35 degrees 36 minutes 20 to 30 seconds north latitude (range shaded in FIG. 6), a filter value, which can specify that range, is set. Then, longitude and latitude data obtained by multiplying the filter value and the latitude and longitude data of the office A is used as an encryption key. As a result, the file can be freely opened in any position within the office A, and cannot be opened in other locations. Namely, the length of a key used for encryption is changed, whereby an arbitrary position range determined by latitude and longitude data can be specified as a location in which a file can be opened.

Turning back to FIG. 4. Upon termination of data encryption, a header and a digest of the encrypted data are generated (step S15 of FIG. 4).

Next, the header storing data which indicates a security level, data encrypted by using position information, and a footer storing the digest are saved as one file (step S16 of FIG. 4).

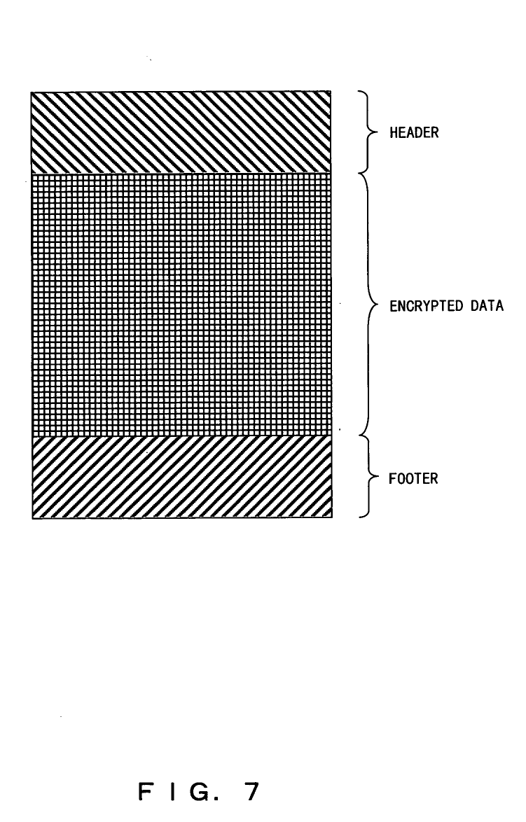

FIG. 7 shows the data structure of an encrypted file, which is created by the above described data saving process.

As shown in FIG. 7, a header composed of data which indicates a security level, etc. is added to the beginning of encrypted data, and a footer composed of a digest of the encrypted data is added to the end of the encrypted data.

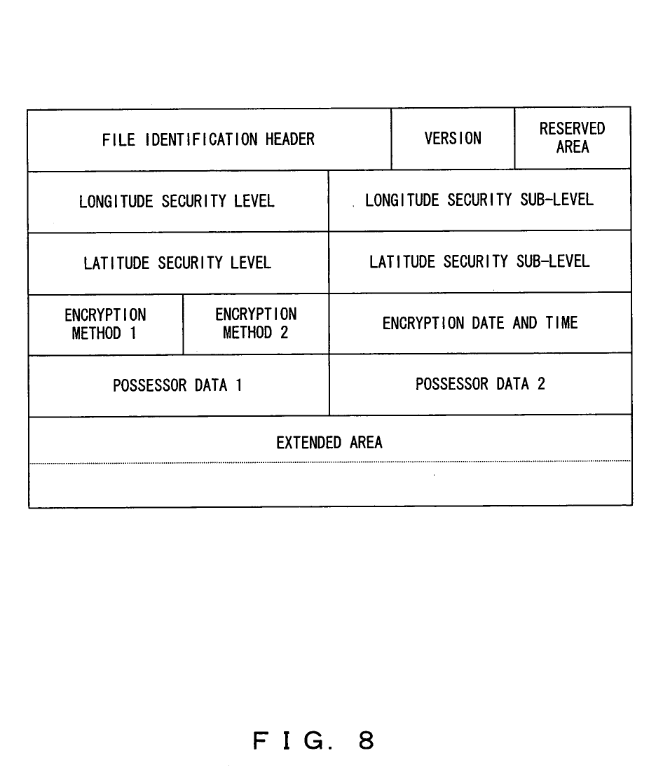

FIG. 8 shows the structure of the header shown in FIG. 7. In the header, a file identification header, longitude and latitude security level data which respectively specify the security levels of latitude and longitude, longitude and latitude security sub-level data which respectively specify the security levels of second or lower data of longitude and latitude data, encryption method data which specifies an encryption method of data (for example, encryption using position information, data specifying encryption using a public key, or the like), data of date and time when encryption is made, and possessor data 1 and 2 which indicate data of a possessor who saves data are set.

The security levels and the security sub-levels of latitude and longitude in the header are used to create a decryption key from GPS position information when a file is opened.

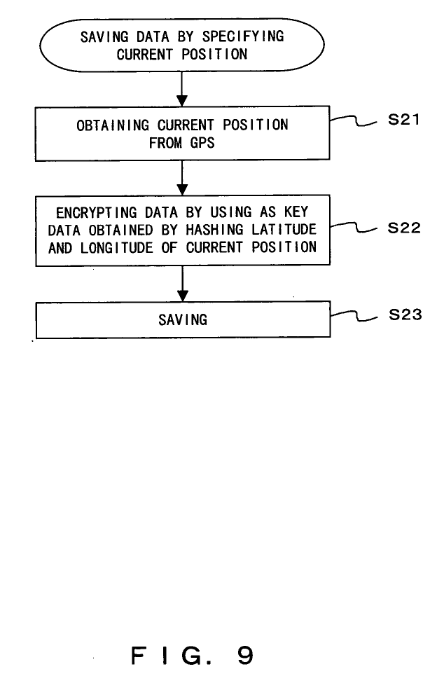

FIG. 9 is a flowchart showing a process executed in the case of “save by specifying the current location” as a location in which a file can be opened.

Firstly, GPS information is obtained from the GPS device 12 (step S21 of FIG. 9). Next, document data is encrypted by using, as a key, data obtained by performing a hash operation for the GPS information in the current position (step S22 of FIG. 9). Then, a header and a footer are added to the encrypted data, which is then saved in a storage device (step S23 of FIG. 9).

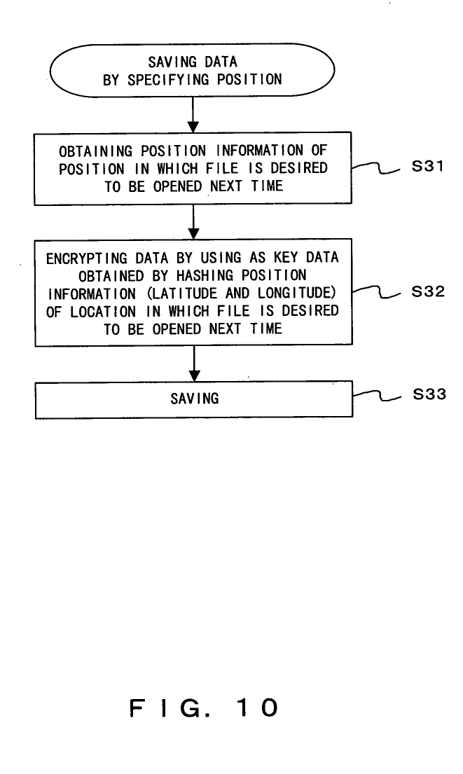

FIG. 10 is a flowchart showing the process executed in the case of “save by specifying latitude and longitude” of a location in which a file can be opened.

If “save by specifying a location” is selected from the tool bar, position information of a preset location, or position information specified by a user at that time is obtained (step S31 of FIG. 10).

Next, data is encrypted by using, as a key, data that is obtained by performing a hash operation for the obtained position information (step S32 of FIG. 10).

Then, a header and a footer are added to the encrypted data, which is then saved in the storage device (step S33 of FIG. 10).

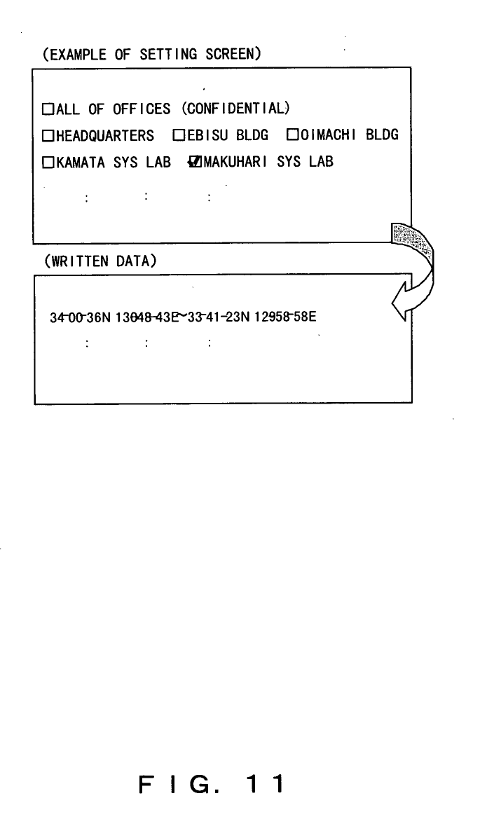

FIG. 11 exemplifies a display of a setting screen on which a location is specified in the case of “save by specifying latitude and longitude”.

In the example shown in FIG. 11, a table which makes a correspondence between each division name of a company and latitude and longitude data of each location is created beforehand.. When a user saves a file by specifying an office name, the latitude and longitude data of the position in which the office exists is read from the table, and the file is encrypted by using the latitude and longitude data as a key.

In this case, the file is encrypted and saved by specifying the office name, whereby the file can be freely opened within the corresponding office, and cannot be opened in a location other than the specified location. As a result, the security of the file can be enhanced with a simple save operation.

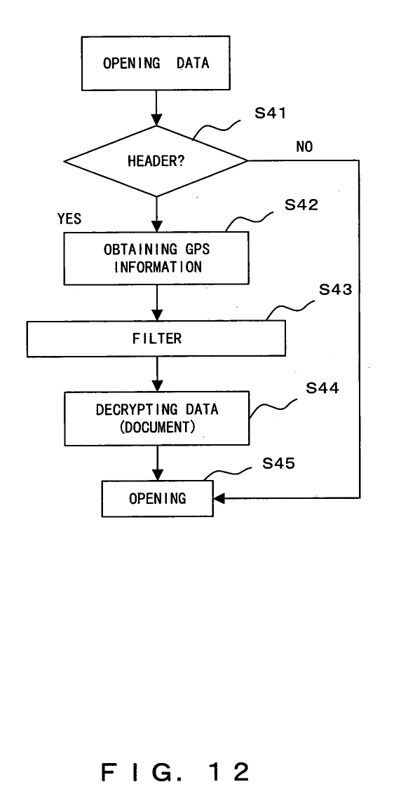

FIG. 12 is a flowchart showing a process executed when a file is opened.

Firstly, whether or not data which indicates a security level of encryption is stored in a header of a file is examined to determine whether or not the file is a file encrypted by using position information (step S41 of FIG. 12).

If the header stores the data which indicates the security level of encryption (“YES” in step S41), the process proceeds to step S42, in which GPS information is obtained from the GPS device 12 added internally or externally.

Next, the GPS information is filtered based on the security level read from the header (step S43 of FIG. 12).

Then, the encrypted data is decrypted by using the filtered GPS information as a key (step S44 of FIG. 12). The decrypted data is then read and displayed (step S45 of FIG. 12).

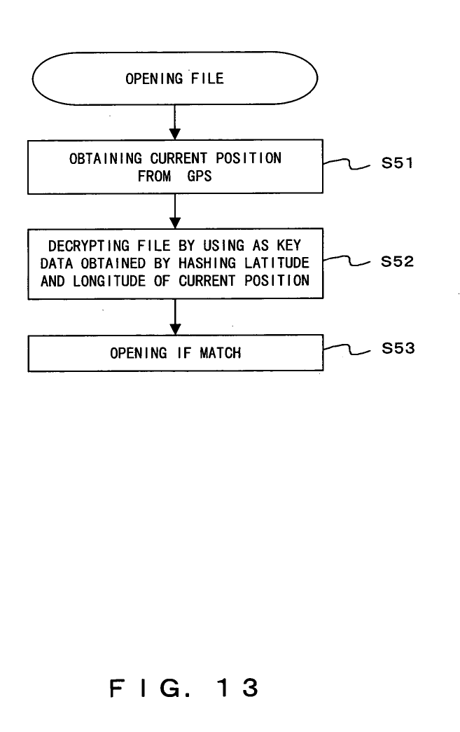

FIG. 13 is a flowchart showing another process executed when an encrypted file is opened by using position information.

Firstly, GPS information (latitude and longitude data) of the current position is obtained from the GPS device 12 (step S51 of FIG. 13). Next, the file is decrypted by using, as a key, data obtained by performing a predetermined hash operation for the latitude and longitude data of the current position (step S52 of FIG. 13). Then, the decrypted data is read and displayed (step S53 of FIG. 13).

According to the above described first preferred embodiment, if an operation for opening a file is performed in a position (including a range determined by position information) specified as a position in which the file can be opened, the file can be decrypted by using the position information of that position, and its contents can be displayed. If a position in which the file is opened is different from the specified position, the file cannot be decrypted by using the position information of that position. Therefore, meaningful data is not displayed.

Accordingly, even if a file is copied in a location in which the file can be opened, and carried outside, the file cannot be opened in a location other than the specified location. As a result, the file can be prevented from being illegally used.

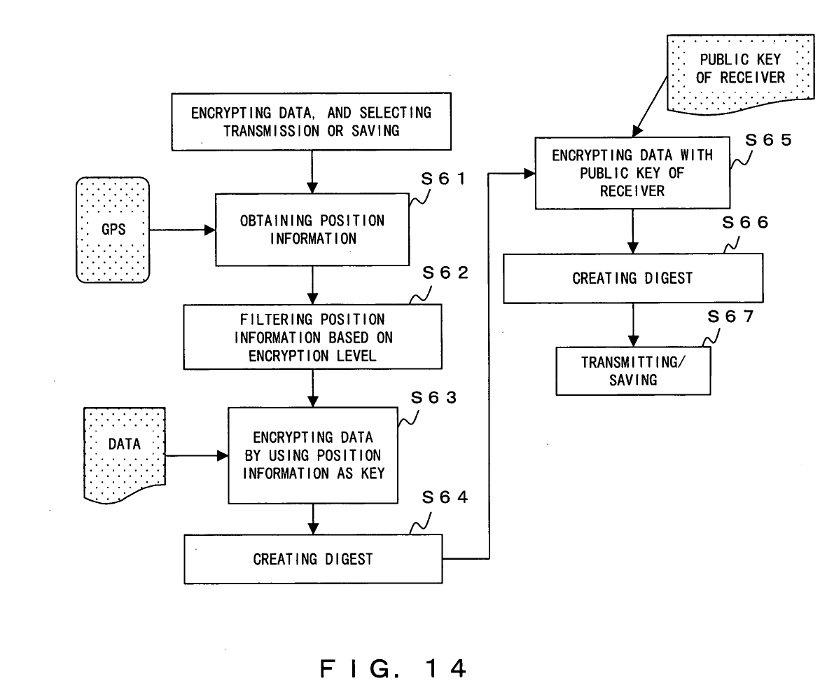

FIG. 14 is a flowchart showing a data transmission/saving process according to a second preferred embodiment of the present invention. The second preferred embodiment is an example where data is encrypted by using position information as a key, and the data encrypted by using the position information is further encrypted with a public key of a receiver, and transmitted and saved.

If the transmission or the saving of a file is specified, the CPU of the information processing device 11 obtains GPS position information from the GPS device 12 (step S61 of FIG. 14).

Next, the position information is filtered based on an encryption level (security level) (step S62 of FIG. 14).

Then, the data is encrypted by using the filtered position information as a key (step S63 of FIG. 14).

Next, a digest of the encrypted data is created (step S64 of FIG. 14). Here, the digest indicates data resultant from a predetermined hash operation performed for the encrypted data.

Next, the data encrypted by using the position information, a header composed of information which indicates an encryption level, etc., and a footer composed of the digest are encrypted with the public key of the receiver of the message (step S65 of FIG. 14).

Then, a predetermined hash operation is performed for the text encrypted with the public key of the receiver (data which is encrypted with the public key and composed of the GPS encryption header portion and the GPS encryption footer portion) to create a digest (step S66 of FIG. 14).

Next, a public key encryption header portion is added to the text encrypted with the public key of the receiver, and the created digest is stored in a public key footer portion, and the data is then transmitted or saved (step S67 of FIG. 14).

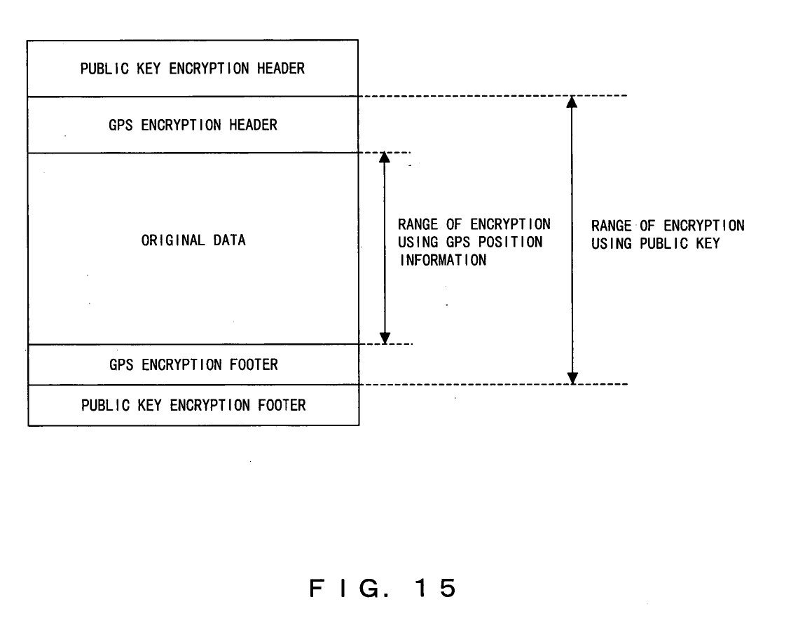

FIG. 15 shows the structure of data created with the above described data transmission/saving process.

As shown in FIG. 15, data to be transmitted is composed of a public key encryption header portion, a text encrypted with a public key, and a public key encryption footer portion storing a digest. The text encrypted with the public key is composed of a GPS encryption header portion storing data which indicates an encryption level, etc., data encrypted by using GPS position information as a key, and a GPS encryption footer storing a digest.

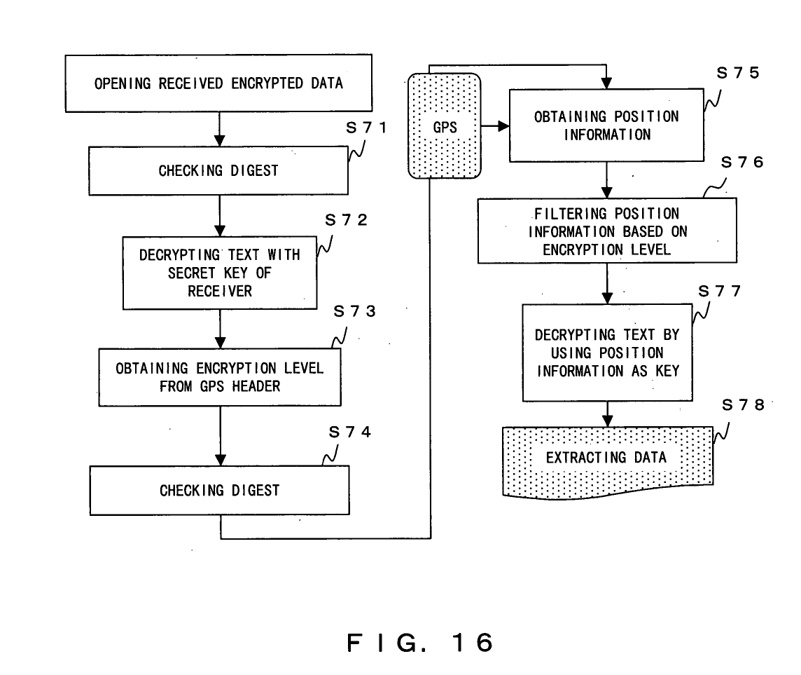

FIG. 16 is a flowchart showing a process executed when a file encrypted by using position information and a public key is received and opened.

A predetermined hash operation is performed for a text encrypted with a public key to create a digest, and whether or not the created digest and a digest stored in a footer portion match is checked (step S71 of FIG. 16).

If the digests match, the encrypted text is decrypted with a secret key of a receiver (step S72 of FIG. 16). As a result of decrypting the encrypted text with the secret key of the receiver, a GPS encryption header portion, a text encrypted with GPS information, and a GPS encryption footer portion are obtained. Then, data which indicates an encryption level is obtained from the GPS encryption header portion (step S73 of FIG. 16).

Next, a predetermined hash operation is performed for the text encrypted by using the position information to create a digest, and whether or not the created digest and the digest stored in the GPS encryption footer portion match is checked (step S74 of FIG. 16).

If the digests match, position information is obtained from the GPS device 12 (step S75 of FIG. 16). The position information is then filtered based on the encryption level obtained from the GPS header portion, and converted into position information having a data length which corresponds to the encryption level (step S76 of FIG. 16).

Next, the encrypted text is decrypted by using the filtered position information as a key (step S77 of FIG. 16).

Then, the decrypted data is extracted and displayed on the display device (step S78 of FIG. 16). The process of step S78 may be executed as a process separate from the process for decrypted encrypted data, or part of its process.

According to the above described second preferred embodiment, a file is encrypted by using, as a key, position information which specifies a position in which the file is opened, and the encrypted data is further encrypted with a public key encryption method and transmitted, whereby a receiver who has a secret key can open the file only when he or she stays in a particular position. As a result, the security of the file can be further enhanced. In the second preferred embodiment, the method encrypting a file by using position information as a key, and an encryption system using a known encryption system can be used together.

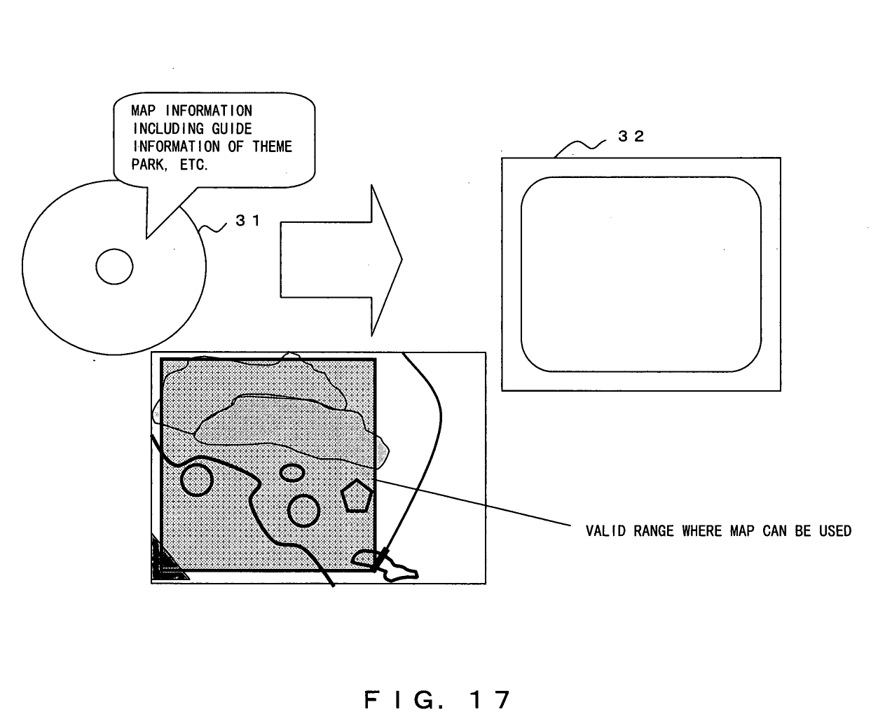

FIG. 17 explains a third preferred embodiment according to the present invention, in which encryption using position information is applied to map information.

According to the third preferred embodiment, map information encrypted by using position information is recorded onto a storage medium such as a CDROM, a DVD, etc. and provided to a user, and the user decrypts the map information by using the position information as a key.

A provider of map information encrypts map information by using, as a key, position information which specifies an area, records the encrypted map information onto a storage medium 31, and sells the storage medium 31.

A user who purchases the storage medium 31 on which the map information is recorded sets the storage medium 31 in a reading device of a car navigation system. When a car driven by the user runs within a valid range where the map can be used, the map information recorded onto the storage medium 31 is decrypted by using, as a key, the position information obtained by a GPS device mounted in the car navigation system, whereby the map information can be displayed on a display device 32 of the car navigation system.

In the meantime, when the car driven by the user runs outside the valid range, the encrypted map information cannot be decrypted even if the user attempts to decrypt the map information by using the position information obtained by the GPS device. Therefore, the map information cannot be displayed on the display device 32.

According to the above described third preferred embodiment, a provider side of map information encrypts map information by using position information as a key, so that a limitation can be imposed on the use of a user to allow the user to use only map information within a permitted range. In the meantime, the user side can display necessary map information without performing a particular input operation for decrypting the map information.

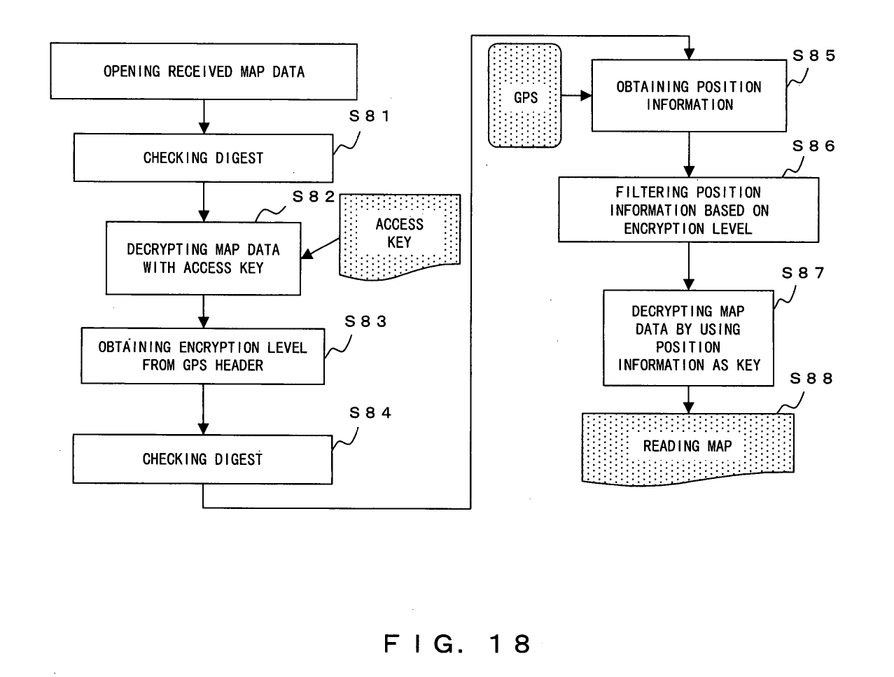

FIG. 18 is a flowchart showing a process for opening encrypted map data, according to a fourth preferred embodiment of the present invention.

According to this fourth preferred embodiment, a company which sells a car navigation system, or the like encrypts map data with an access key and position information and transmits the encrypted map data to a user, and the user decrypts the map data with the position information and the access key.

The map data in the fourth preferred embodiment is encrypted with position information that specifies an area where the map data can be decrypted, and the encrypted map data is further encrypted with the access key that indicates a user right of the user.

Firstly, a predetermined hash operation is performed for encrypted map data that is received wirelessly or via a communications line to create a digest, and whether or not the created digest and a digest added to the map data match is checked (step S81 of FIG. 18).

If the digests match, the map data is decrypted with the access key given to the user (step S82 of FIG. 18).

Next, data that indicates an encryption level is obtained from a GPS encryption header portion of the decrypted data (step S83 of FIG. 18).

Then, a predetermined hash operation is performed for the data decrypted with the access key to create a digest, and the created digest is checked by being compared with a digest added to a GPS encryption footer (step S84 of FIG. 18).

If the digests match, position information of the current position is obtained from the GPS device (step S85 of FIG. 18). Furthermore, the position information is filtered based on the encryption level obtained from the header (step S86 of FIG. 18). In the process of step S86, the position information is filtered by truncating data of the position information by a certain number of low-order digits according to the encryption level, and a limitation is imposed on a position range in which the encrypted data can be decrypted.

Next, the map data is decrypted by using the filtered position information as a key (step S87 of FIG. 18).

Then, the decrypted map data is read and displayed on a display device of a car navigation system (step S88 of FIG. 18). The process of this step S88 may be included in the process for decrypting encrypted map data, or may be executed as a process separate from the decryption process.

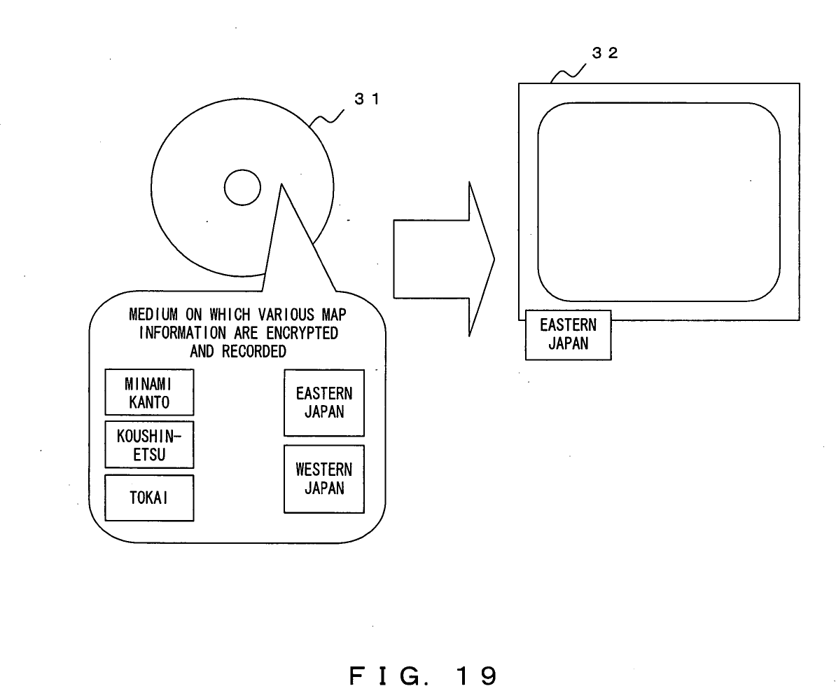

FIG. 19 explains the case where map information of a plurality of areas are encrypted and recorded on a single storage medium (CDROM, DVD, etc.).

The example shown in FIG. 19 is intended to encrypt map information of a plurality of areas by using, as keys, an access key and position information which specify the areas, to record the encrypted map information onto a storage medium 31, and to give an access key, in which a use right of areas that the user can use is set, to the user who purchases the map information.

The user who purchases the storage medium 31 on which the map information is recorded sets the storage medium 31 in a reading device of a car navigation system, and inputs the access key given from a seller of the map information. The car navigation system decrypts the map information recorded on the storage medium 31 by using as keys the access key and the current position information obtained by a GPS device.

For example, if the user purchases map information of South Kanto, the map information is decrypted by using as keys an access key in which a use right of the map information of South Kanto is set and the position information obtained by the GPS device, so that the map information of South Kanto can be displayed on the display device 32. In this case, since map information of other areas cannot be used with that access key, it cannot be decrypted.

Additionally, if the user purchases map information of eastern Japan, the map information is decrypted by using as keys an access key in which a use right of the map information of eastern Japan is set, and the position information obtained by the GPS device, whereby the map information of all of areas of eastern Japan can be displayed on the display device of the car navigation system.

In the example shown in FIG. 19, map information of all of areas in Japan are encrypted by using as keys an access key and position information of each of the areas, and recorded on a single storage medium 31, whereby a range of map information that a user can use can be arbitrarily set. Additionally, storage media 31, which are provided to a plurality of users whose use ranges of the map information are different, can be made common. As a result, the number of man-hours required to create the storage media 31 can be reduced. Furthermore, a user can use map information of a plurality of areas with a single storage medium by acquiring an access key with which the plurality of areas can be used, even if the user requires the map information of the plurality of areas.

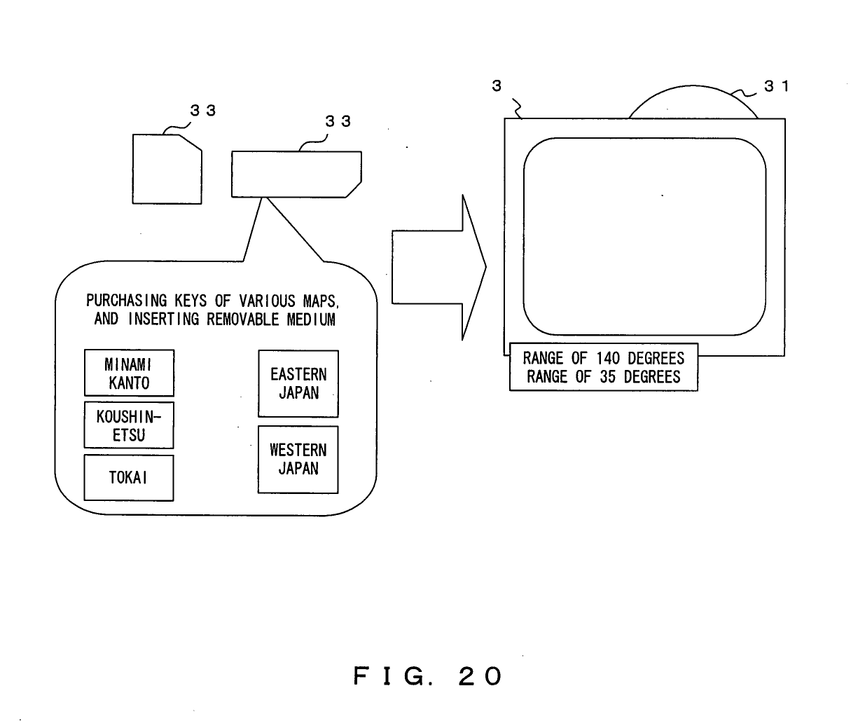

FIG. 20 explains the case where an access key is saved on a removable medium.

Procedures for decrypting map information in the example shown in FIG. 20 are fundamentally the same as those of the example shown in FIG. 19. A difference exists in a point that an access key is saved on a removable medium 33, and a user can decrypt map information of an area whose use right is possessed by the user by inserting the removable medium 33 into a removable medium reading device of a car navigation system when the user uses the map information.

In the example shown in FIG. 20, a user can display necessary map information only by inserting the removable medium into the reading device, so that the user does not need to remember the access key in addition to the effects of the encryption method shown in FIG. 19. Furthermore, a map information provider side can prevent the access key from being copied to illegally use map information. This is because the map information cannot be decrypted if the removable medium is not used.

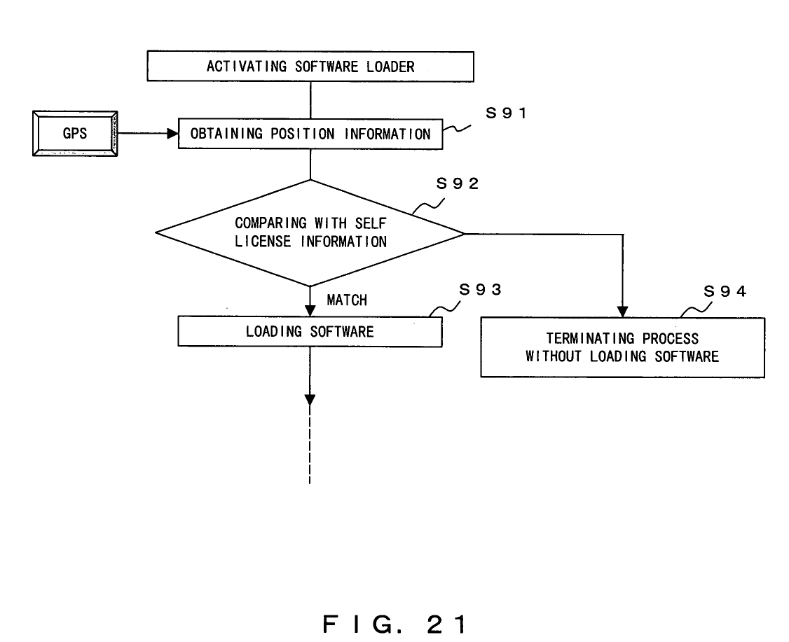

FIG. 21 is a flowchart showing a process for executing a license protection file, according to a fifth preferred embodiment of the present invention.

This fifth preferred embodiment shows an example where encryption using position information is applied to software execution. A provider that provides software via a communications line makes a user input a location in which a computer is installed when the user purchases a license for downloading the software, and issues position information that identifies the location as license information. The license information may be issued offline at this time.

When the user obtains the license information for loading/executing or downloading the software, he or she accesses a server to start the procedures for downloading the software.

Firstly, position information is obtained from a GPS device connected to the computer (step S91 of FIG. 21).

Next, a comparison is made between the position information obtained from the GPS device and the license information, and whether or not the position information and the license information match (step S92 of FIG. 21).

If the position information and the license information match, the process proceeds to step S93, in which the software program is downloaded from the server and decrypted with the license information to regenerate the original program. When the program is transmitted from the server, it is transmitted by being encrypted with the position information which is registered by the user. The same method can be used also in the case where the program is downloaded not from a network but from a disk into a memory. Accordingly, this method can be applied to a stand-alone system.

If the position information obtained from the GPS device and the license information mismatch, the process is terminated without downloading the software (step S94 of FIG. 21).

According to the above described fifth preferred embodiment, loading/execution or downloading of software (a software program?) can be made only in a location which is registered when an access key is obtained and in which a computer is installed, and cannot be made even if an access key is illegally obtained. Accordingly, the program can be prevented from being illegally obtained, and protection of the software can be further strengthened. Additionally, the program cannot be decrypted in a position other than a specified position by encrypting the program with position information, whereby the program cannot be used in other locations even if it is copied.

Note that a license key, which is given to a user who purchases the software, may be encrypted with position information of a location in which a computer of the user is installed, and may be issued.

In this way, a license key cannot be properly decrypted in a location other than a registered location when a program is downloaded or installed with the license key, whereby the same license key cannot be used in a plurality of locations. In this case, the program itself does not need to be encrypted with position information.

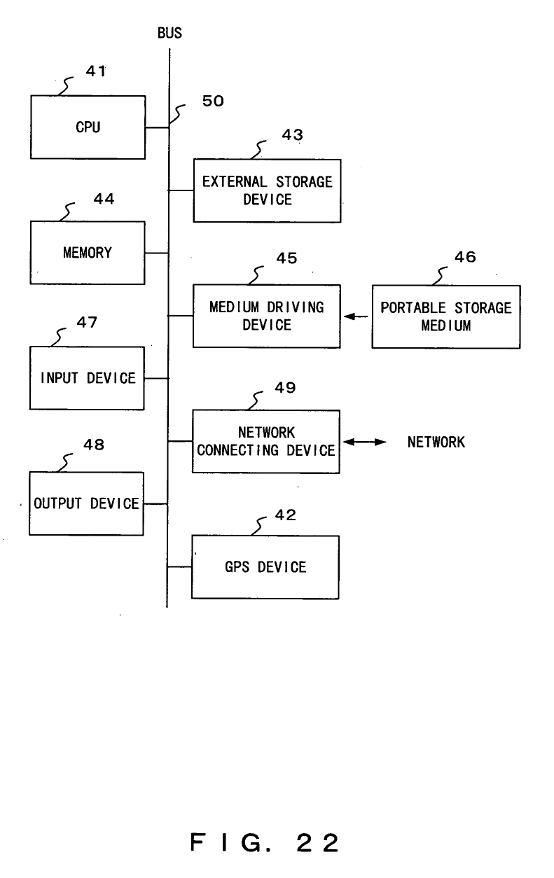

An example of hardware configuration of an information processing device 11 according to a preferred embodiment is described next with reference to FIG. 22.

A CPU 41 executes a process for encrypting and saving data with position information, a process for decrypting the data encrypted with the position information, and the like. A GPS device 42 receives radio waves from a plurality of satellites, and calculates position information of a current position.

In an external storage device 43, a program executed by the CPU 41 is stored, and also data of a process result, etc. are stored. A memory 44 is used as various types of registers used for arithmetic operations.

A storage medium driving device 45 reads/writes from/to a portable storage medium 46 such as a CDROM, a DVD, a flexible disk, an IC card, etc.

An input device 47 is a device inputting data, such as a keyboard, etc. An output device 48 is a display device, etc.

A network connecting device 49 is a device for making a connection to a network such as a LAN, the Internet, etc. A program can be downloaded from a server of an information provider on the network via this device. Note that the CPU 41, the memory 44, the external storage device 43, etc. are interconnected by a bus 50.

The above described preferred embodiments refer to the cases where the security management program according to the present invention is embedded as a plug-in of a document creation application. However, the present invention is not limited to these implementations, and can be implemented as a dedicated program for encrypting a file or data by using position information as a key and for storing the encrypted file or data, or for transmitting the encrypted file or data.

According to the present invention, a file can be freely opened in a location specified when the file is stored, but cannot be decrypted and opened in other locations, whereby the security of the file can be enhanced. Additionally, data is encrypted with position information and recorded onto a storage medium, so that a limitation is imposed on a location in which a user can use the data. Furthermore, a program is encrypted with position information, whereby a limitation is imposed on a location in which a user can use the program.

What is claimed is:

1. A file security management method, comprising:
encrypting a file by using, as a key, position information which specifies a position in which the file can be opened;
saving the encrypted file;
decrypting the file by using, as a key, position information which is detected by a position detecting device; and
displaying the decrypted file.

2. The file security management method according to claim 1, wherein
a selection is made from among a plurality of preregistered positions when position information in which the file can be decrypted is selected.

3. The file security management method according to claim 1, wherein
a limitation is imposed on a position range in which the file can be opened by changing a data length of position information which is used as an encryption key.

4. A file security management method, comprising:
saving data that is encrypted by using, as a key, position information which specifies a position in which the data can be used, and the position information as a key;
determining whether or not position information which is detected by a position detecting device and the saved key match, and decrypting the encrypted data by using the key if the position information and the saved key match; and
displaying the decrypted data.

5. A file security management apparatus, comprising:
an encrypting unit encrypting a file by using, as a key, position information which specifies a position in which the file can be opened;
a saving unit saving the encrypted file;
a decrypting unit decrypting the file by using, as a key, position information which is detected by a position detecting device; and
a displaying unit displaying the file decrypted by said decrypting unit.

6. A file security management method, comprising:
encrypting a file by using, as a key, position information which specifies a position in which the file can be opened; and
saving the encrypted file.

7. A file security management method, comprising:
decrypting an encrypted file by using, as a key, position information which is detected by a position detecting device, when opening the file; and
displaying the decrypted file.

8. A file security management method, comprising:
encrypting data by using position information which specifies a position in which the data can be used; and
transmitting the encrypted data, or saving the encrypted data onto a computer-readable storage medium.

9. The file security management method according to claim 8, wherein
a limitation is imposed on a position range in which a file can be opened by changing a data length of position information used as an encryption key.

10. A computer-readable storage medium on which map information is recorded, wherein:
map data encrypted with position information which specifies a position in which a user can use the map data is recorded; and
map data, which can be decrypted only if position information detected by a position detecting device and the position information used to encrypt the map data match, is recorded.

11. A program security management method, comprising:
encrypting a program with position information which specifies a position in which the program can be used; and
transmitting the program encrypted with the position information, or saving the encrypted program onto a computer-readable storage-medium.

12. The program security management method according to claim 11, wherein
the program is encrypted with the position information, and a license key given to a user.

13. A computer-readable storage medium on which is recorded a program that is encrypted with position information which specifies a position in which the program can be used.

14. A program security management method, comprising:
encrypting a program with position information which specifies a position in which the program can be used;
transmitting the program encrypted with the position information, and a license key given to a user;
receiving, by the user, the encrypted program and the license key; and
decrypting the encrypted program with position information which is detected by a position detecting device, and the license key.

15. A file security management apparatus, comprising:
encrypting unit encrypting a file by using, as a key, position information which specifies a position in which the file can be opened; and
saving unit saving the encrypted file.

16. A file security management apparatus, comprising:
a decrypting unit decrypting a file by using, as a key, position information which is detected by a position detecting device; and
a displaying unit displaying the file decrypted by said decrypting unit.

17. A computer-readable storage medium on which is recorded a security management program for causing a computer to execute a process, the process comprising:
encrypting a file by using, as a key, position information which specifies a position in which the file can be opened;
saving the encrypted file;
decrypting the file by using, as a key, position information which is detected by a position detecting device, when opening the file; and
displaying the decrypted file.

18. The computer-readable storage medium according to claim 17, the process further comprising
imposing a limitation on a position range in which the file can be opened by changing a data length of position information used as an encryption key.

19. A computer-readable storage medium on which is recorded a security management program for causing a computer to execute a process, the process comprising:
encrypting a file by using, as a key, position information which specifies a position in which the file can be opened; and
saving the encrypted file.

20. A computer-readable storage medium on which is recorded a program for reading map data from a storage medium on which is recorded map data encrypted with position information which specifies a position in which the map data can be used, the program comprising
allowing the map data to be decrypted only if position information detected by a position detecting device and the position information used to encrypt the map data match.
